(19) United States
(12) Patent Application Publication
(10) Pub. No.: US 2012/0278366 A1
(43) Pub. Date: Nov. 1, 2012

(54) CREATION AND USE OF ORPHAN OBJECTS

(75) Inventors: Matthew J. Insko, Milford, OH (US); Niranjan K. Iyer, San Diego, CA (US)

(73) Assignee: SIEMENS PRODUCT LIFECYCLE MANAGEMENT SOFTWARE INC., Plano, TX (US)

(21) Appl. No.: 13/246,952

(22) Filed: Sep. 28, 2011

Related U.S. Application Data
(60) Provisional application No. 61/480,822, filed on Apr. 29, 2011.

(51) Int. Cl. G06F 17/30

(52) U.S. Cl. 707/802; 707/E17.005

(57) ABSTRACT

Product data management systems, methods, and mediums. A method includes receiving a request to create an object. The method includes determining that the system is in a conditional mode. The method includes creating an orphan object in response to the request and in response to determining that the system is in the conditional mode. The orphan object corresponds to a hierarchy but is not included in the hierarchy. The conditional mode is one of a deferred session or an exploratory session.

### CROSS-REFERENCE TO RELATED APPLICATION

This application claims the benefit of the filing data, of U.S. Provisional Patent Application 61/480,822, filed Apr. 29, 2011, which is hereby incorporated by reference.

### TECHNICAL FIELD

The present disclosure is directed, in general, to computer-aided design, visualization, and manufacturing systems (“CAD systems”), product lifecycle management (“PLM”) systems, project management systems, and systems that manage data for products and other items (individually and collectively, product data management (“PDM”) systems).

### BACKGROUND

PDM systems can aid users in creating and managing project schedules, among other functions, including the scheduling of tasks. PDM systems also maintain schedules, tasks, and other data objects that may occasionally be edited by different processes.

### SUMMARY OF THE DISCLOSURE

Various disclosed embodiments relate to systems and methods for creation and use of orphan objects with particular utility in schedule management functions, and in particular in PDM systems configured to perform processes as described herein.

Various embodiments include PDM systems, methods, and mediums. A method includes receiving a request to create an object. The method includes determining that the system is in a conditional mode. The method includes creating an orphan object in response to the request and in response to determining that the system is in the conditional mode. The orphan object corresponds to a hierarchy but is not included in the hierarchy. The conditional mode is one of a deferred session or an exploratory session.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented in accordance with disclosed embodiments;

FIG. 2 illustrates an example of an orphan task in accordance with disclosed embodiment; and

FIGS. 3-5 depict flowcharts of processes in accordance with disclosed embodiments.

### DETAILED DESCRIPTION

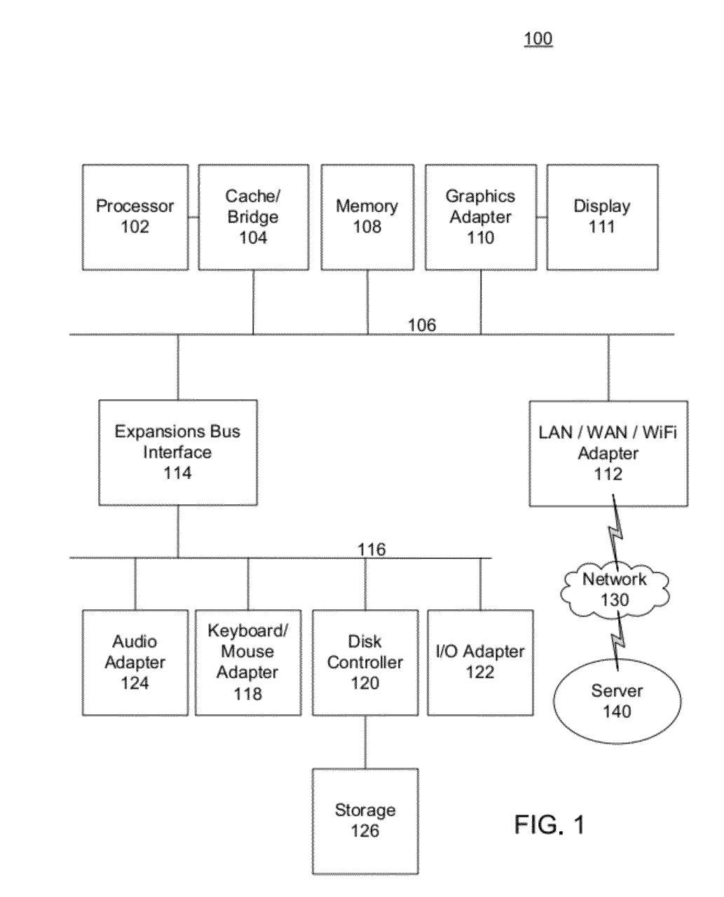

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Project management systems and other PDM systems have a high level of interdependencies. Tasks are dependent on resource availability and the completion of other tasks. A minor change can cause a “ripple” of changes which cascade across multiple objects in a schedule. In a collaborative system, each of these changes must be persisted to enforce data integrity and allow concurrency, among other reasons.

To support the cases of cascading effect of objects like a chain of dependent tasks, various disclosed embodiments can support partial objects that are created in the server or database to maintain data integrity before a deferred session or “what-if” analysis can be worked on. Various embodiments also preserve security and prevent others from accessing the objects while accessing the project.

In modern enterprise-level systems, a deferred session environment where changes made on the client side are batch processed and sent to the server becomes very important to reduce the roundtrips and transactional overheads among other things. Companies can use deferred save or alternate methods to delay the persisting of data to the database until it is batch processed or required.

There are typically three kinds of interaction modes. These include live interactions, where changes go to the database in a synchronous fashion, deferred-save interactions, where changes are accumulated on a client and batch processed to reduce network traffic, and hybrid interactions, where certain changes are persisted immediately while others are done in batch mode. Systems encounter different failure scenarios where it is important for customers to not lose their data and it is also important to maintain data integrity in the server. In a hybrid non-offline deferred environment of a project management system as above, to preserve data integrity for example in case of a power failure, a system as disclosed herein can create task objects in the database with partial data.

In project and program management systems, project managers require certain objects to be created within a schedule in such a fashion that the managers have access to the object while other users don't access it until the plan is fully complete. Instances where this is required could include a major re-plan of a schedule while the schedule is undergoing execution. It is extremely important for this task/object to preserve the security access in not being available to anyone else other than the creator.

As used herein, a “project” refers to a schedule or project plan in a project management or PDM system. A “task” refers to activities or tasks defined within a project. A “deferred session” refers to a client session where changes are persisted to the database as a batch process at a later point in time. An orphan task refers to a loosely-tied task that exists in the database but is not associated to the project hierarchy structure. An “orphan object” refers to a data object, including an orphan task, that exists in the database but is not associated to the hierarchy structure to which it would otherwise below, as contrasted to “normal” objects that are part of the hierarchy structure. A task can be any kind of task or similar object, including milestones, summary tasks, phase tasks, gate tasks, and proxy tasks.

Disclosed embodiments include systems and methods for creating, maintaining, and manipulating orphan tasks in a PDM system.

FIG. 1 depicts a block diagram of a data processing system in which an embodiment can be implemented, including as a PDM system particularly configured to perform processes as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Various embodiments include systems and methods that include loosely-coupled orphan tasks in a project management or other PDM system.

An “orphaned” task is a loosely-tied task or customized subtype that exists in the database but is not associated to the hierarchy or other structure of a project. The orphaned task or object can correspond to a structure, and can include information as to its place in the structure for when and if it is integrated. In the examples below, the specific structure used is a hierarchy, but any other appropriate data structure can be used.

In various embodiments, an orphan task can have one or more of the following characteristics. An orphan task is a task that does not have a specific position in the project hierarchy structure. In an orphan task, not all the attributes of the task are necessarily populated. An orphan task can be secured so that only an owner, administrator, or person with sufficient rights has access to view or edit it. An orphan task is not visible to any other user reading the project, and can exist for the life of the project.

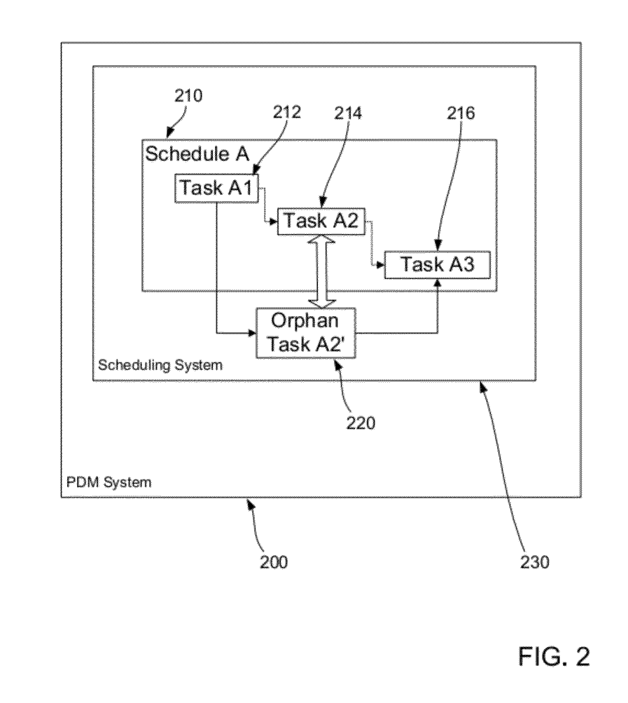

FIG. 2 illustrates an example of an orphan task in accordance with disclosed embodiments. In this example, a PDM system 200 implements a scheduling system 230. The scheduling system 230 maintains a Schedule A 210. Schedule A 210 has a specific hierarchy that originally includes task A1 212 and task A3 216.

Scheduling system 230 also maintains an orphan task A2′ 220. In this example, task A3 216 is dependent on orphan task A2′ 220, which in turn is dependent on task A1 212 (illustrated using solid arrows). As described herein, even if schedule A 210 is accessible to various different users, orphan task A2′ 220 can have limited access to its creator, administrators, or other groups or individuals that are different than those that can access schedule A 210.

In various embodiments, an orphan task is in the same database as the structure and other objects, and thus is allowed to have dependencies from and to the orphan task with other real tasks. So, in this example, initially, there could be A1 212, A2′ 220, and A3 216. The creator of A2′ 220 can see A2′ 220 and the dependencies to A2′ 220. Other users cannot see A2′ 220 and will only see A1 212 and A3 216. When Orphan task A2′ 220 gets promoted to a real task A2 214, all its dependencies and resource assignments and deliverables associated to it can go along with it. So, once orphan task is “promoted,” then orphan task A2′ 220 doesn't exist and only A1 212, A2 214, and A3 216 exist in the hierarchy. The resulting schedule will task A3 216 is dependent on task A2 214, which in turn is dependent on task A1 212 (illustrated using dashed arrows).

The system can create an orphan task, for example in a deferred or what-if mode, when a new task, milestone, phase-gate task, or other kind of task is created. In such cases, an orphaned task can be created and persisted in the database for them. If the session is cancelled, these orphan tasks can be deleted. If the session is saved, these tasks can be integrated with the structure. The orphan task can be created automatically in response to the other kind of task being created.

The system can create an orphan task when there is a failure during a delete operation on normal task. In such a case, the system can automatically convert the normal task into an orphaned task. This orphan task can then be permanently deleted during cleanup process.

In various embodiments, an orphan task can be integrated back into a project automatically or manually when a deferred or “what-if” session is saved. An orphan task can also be integrated back into a project in response to a user interaction, for example from a separate dialog where the orphan task can be chosen by a user and then integrated into the project structure.

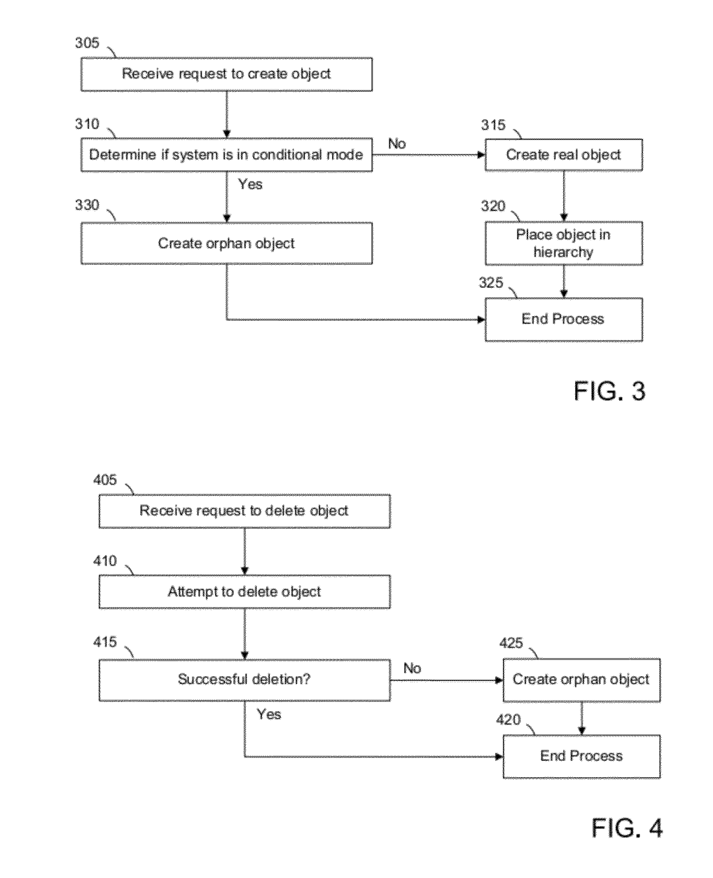

FIG. 3 depicts a flowchart of a process in accordance with disclosed embodiments for creating an orphan task. This process, and the others described herein, can be performed by one or more PDM systems, referred to in the singular below as “the system”.

The system receives a request to create a new object (step 305). This object can be a task. “Receiving”, as used herein, can include loading from storage, receiving from another device or process, receiving via an interaction with a user, or otherwise.

The system determines if the system is operating is a conditional mode (step 310). The conditional mode is used when a user is operating in a deferred session or a “what-if exploratory session.

If the system is not operating in a conditional mode, the system creates a normal or “real” object (step 315). The system places the normal object in a hierarchy (step 320) and the process ends (step 325). In various embodiments, the normal object is a normal task, and the hierarchy is a project or schedule hierarchy.

If the system is operating in a conditional mode, the system creates an orphan object (step 330) and the process ends (step 325). The orphan object can be an orphan task The orphan object can include a reference to a real object in the hierarchy.

FIG. 4 depicts a flowchart of a process in accordance with disclosed embodiments for creating an orphan task.

The system receives a request to delete an object (step 405). This object can be a task. The object can be a normal object in a hierarchy, and can be a task. The hierarchy can represent a schedule in a schedule manager.

The system attempts to delete the object from a database (step 410). The database can be local or remote, and in particular can be a database on a remote server. The database can be updated on a live basis or on a deferred/batch basis.

The system determines if the object was successfully deleted from the database (step 415). If it was, then the process ends (step 420).

If the object was not successfully deleted, the system creates an orphan object corresponding to the object for which deletion was requested (step 425). The process can end (step 420). The system can also later delete the real object from the database, and when that is successful, the system can then delete the orphan object corresponding to the deleted object.

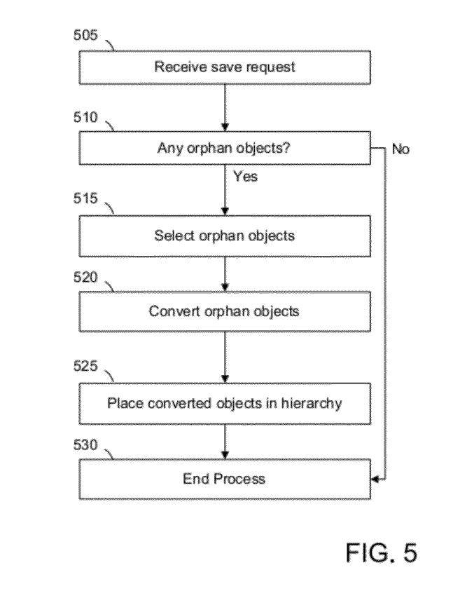

FIG. 5 depicts a flowchart of a process in accordance with disclosed embodiments for integrating an orphan task. This process, and the others described herein, can be performed by one or more PDM systems, referred to in the singular below as “the system”.

The system receives a request to save a hierarchy including a plurality of objects (step 505). The objects can be tasks, and the hierarchy can represent a schedule in a schedule manager.

The system determines if the hierarchy corresponds to any orphan objects (step 510). This step can include gathering and displaying any orphan objects to a user. If there are no corresponding orphan objects, the process can end (step 530).

The system selects which orphan objects to integrate to the hierarchy (step 515). This step can be performed automatically by selecting all orphan objects that correspond to the hierarchy. This step can be performed by receiving a user selection of orphan objects to be integrated.

The system converts the selected orphan objects to real objects (step 520).

The system places the converted objects into the hierarchy (step 525). This can be performed automatically using information in each (converted) real object that specifies its place in the hierarchy. This step can be performed by receiving a user selection of a place in the hierarchy. Along with placing the converted real object in the hierarchy, the system can also place all of its associations including dependencies, assignments, etc. in the hierarchy.

The process ends (step 530).

The various embodiments disclosed herein have significant differences from conventional PDM systems. Disclosed systems can use loosely-tied orphan tasks, and in some embodiments, these can be visible in the project or schedule only to the creator while in a what-if or deferred mode. An orphan task as described herein can have the same or similar characteristics as a regular task, for example in that it can be linked, assigned resources, change dates, etc. A normal task can be converted to an orphan task on a failure on delete or on deferred mode, and an orphan task can be integrated back into the project hierarchy.

Various embodiments can also implement a query function to allow user to search for all orphaned tasks.

Unless otherwise described, the various processes, actions, and steps described above can be performed concurrently, sequentially, in a different order, or omitted in various embodiments, or can be combined in other embodiments.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method performed by a product data management (PDM) data processing system, comprising:
receiving a request to create an object;
determining that the system is in a conditional mode; and
creating an orphan object in response to the request and in response to determining that the system is in the conditional mode, the orphan object corresponding to a structure but not included in the structure,
wherein the conditional mode is one of a deferred session or an exploratory session.

2. The method of claim 1, wherein the orphan object is an orphan task.

3. The method of claim 1, wherein the structure is a schedule maintained by a scheduling system.

4. The method of claim 1, wherein the orphan object includes information for placing the orphan object in the structure.

5. The method of claim 1, wherein the PDM system also saves the structure, including converting at least one orphan object into a real object and placing the converted real object in the structure.

6. The method of claim 1, wherein the PDM system also creates an orphan object when an operation to delete a real object in the structure is unsuccessful.

7. The method of claim 1, wherein the structure is stored in a database in a remote server system.

8. A product data management (PDM) data processing system, comprising:
at least one processor; and
an accessible memory, wherein the PDM data processing system is configured to:
receive a request to create an object;
determine that the system is in a conditional mode; and
create an orphan object in response to the request and in response to determining that the system is in the conditional mode, the orphan object corresponding to a structure but not included in the structure,
wherein the conditional mode is one of a deferred session or an exploratory session.

9. The PDM data processing system of claim 8, wherein the orphan object is an orphan task.

10. The PDM data processing system of claim 8, wherein the structure is a schedule maintained by a scheduling system.

11. The PDM data processing system of claim 8, wherein the orphan object includes information for placing the orphan object in the structure.

12. The PDM data processing system of claim 8, wherein the PDM system also saves the structure, including converting at least one orphan object into a real object and placing the converted real object in the structure.

13. The PDM data processing system of claim 8, wherein the PDM system also creates an orphan object when an operation to delete a real object in the structure is unsuccessful.

14. The PDM data processing system of claim 8, wherein the structure is stored in a database in a remote server system.

15. A non-transitory computer-readable medium encoded with executable instructions that, when executed, cause a product data management (PDM) data processing system to:
receive a request to create an object;
determine that the system is in a conditional mode; and
create an orphan object in response to the request and in response to determining that the system is in the conditional mode, the orphan object corresponding to a structure but not included in the structure,
wherein the conditional mode is one of a deferred session or an exploratory session.

16. The computer-readable medium of claim 15, wherein the orphan object is an orphan task.

17. The computer-readable medium of claim 15, wherein the structure is a schedule maintained by a scheduling system.

18. The computer-readable medium of claim 15, wherein the orphan object includes information for placing the orphan object in the structure.

19. The computer-readable medium of claim 15, wherein the PDM system also saves the structure, including converting at least one orphan object into a real object and placing the converted real object in the structure.

20. The computer-readable medium of claim 15, wherein the PDM system also creates an orphan object when an operation to delete a real object in the structure is unsuccessful.

21. The computer-readable medium of claim 15, wherein the structure is stored in a database in a remote server system.
